(19) United States
(12) Patent Application Publication
(10) Pub. No.: US 2024/0152622 A1
(43) Pub. Date: May 9, 2024

(54) SYSTEM AND METHOD FOR SCORING SECURITY ALERTS INCORPORATING ANOMALY AND THREAT SCORES

(71) Applicant: VMware, Inc., Palo Alto, CA (US)

(72) Inventors: Shugao XIA, Newton, MA (US); Ritika SINGHAL, San Jose, CA (US); Jonathan James OLIVER, Kew (AU); Raghav BATTA, Livermore, CA (US); Jue MO, Boca Raton, FL (US); Aditya CHOUDHARY, San Jose, CA (US)

(21) Appl. No.: 17/984,047

(22) Filed: Nov. 9, 2022

(51) Int. Cl. G06F 21/57; G06F 21/55

(52) U.S. Cl. CPC G06F 21/577; G06F 21/552; G06F 2221/034

(57) ABSTRACT

A method of scoring alerts generated by a plurality of endpoints includes the steps of: in response to a new alert generated by a first endpoint of the plurality of endpoints, generating an anomaly score of the new alert; identifying a rule that triggered the new alert and determining a threat score associated with the rule; and generating a security risk score for the new alert based on the anomaly score and the threat score and transmitting the security risk score to a security analytics platform of the endpoints.

### BACKGROUND

It has become increasingly critical for security systems to generate contextual, timely, and actionable alerts such that security analysts can initiate speedy mitigation measures. Unfortunately, in a typical security operations center, the number of alerts that are generated far outnumber the number of security analysts that can effectively triage them. As a result, critical alerts are often missed by the security analysts due to fatigue and burnout. In addition, many critical alerts are identified too late for mitigation measures to be effective.

### SUMMARY

One or more embodiments provide a method of scoring alerts generated by a plurality of endpoints includes the steps of: in response to a new alert generated by a first endpoint of the plurality of endpoints, generating an anomaly score of the new alert; identifying a rule that triggered the new alert and determining a threat score associated with the rule; and generating a security risk score for the new alert based on the anomaly score and the threat score and transmitting the security risk score to a security analytics platform of the endpoints.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of a virtual computing environment which employs a cloud-based security platform according to embodiments.

FIG. 2 is a block diagram that illustrates components of the cloud-based security platform.

FIG. 3 is a diagram that illustrates a sequence of commands issued and operations carried out to generate cluster profiles.

FIG. 4 is a diagram that illustrates a sequence of commands issued and operations carried out to generate security risk scores of alerts according to embodiments.

FIG. 5 is a flow diagram of a method of scoring alerts according to embodiments.

FIG. 6 is a diagram illustrating a prevalence anomaly scoring method implemented in the method of FIG. 5.

FIG. 7 is a diagram illustrating a legitimate anomaly scoring method implemented in the method of FIG. 5.

FIG. 8 is a look-up table employed in a threat scoring method implemented in the method of FIG. 5.

### DETAILED DESCRIPTION

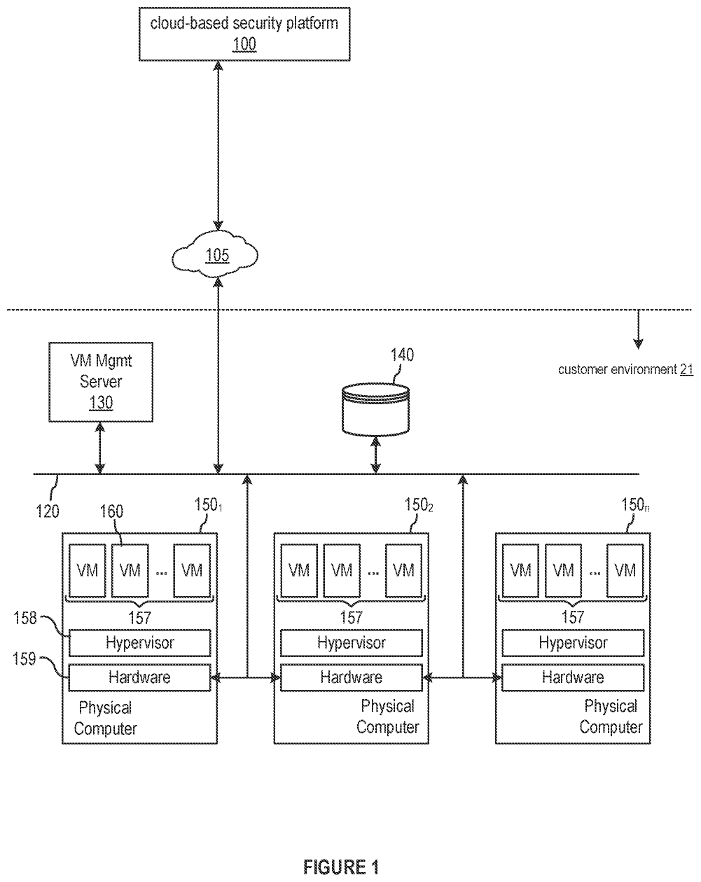

FIG. 1 is a block diagram of a virtual computing environment which is deployed in a customer environment 21 and employs a cloud-based security platform 100, according to embodiments. In the embodiments illustrated herein, virtual computing instances that are provisioned in the virtual computing environment are VMs, and the provisioning of the VMs are managed by a VM management server 130. In some embodiments, virtual computing instances provisioned in the virtual computing environment are containers.

As used herein, a “customer” is an organization that has subscribed to security services offered through cloud-based security platform 100. A “customer environment” means one or more private data centers managed by the customer, which is commonly referred to as “on-prem,” a private cloud managed by the customer, a public cloud managed for the customer by another organization, or any combination of these.

As illustrated in FIG. 1, VMs 157 are deployed on a plurality of physical computers 1501, 1502, . . . , 150n, (also referred to as “host computers”), which VM management server 130 manages as a cluster to provide cluster-level functions, such as load balancing across the cluster through VM migration between the hosts, distributed power management, dynamic VM placement according to affinity and anti-affinity rules, and high availability (HA). VM management server 130 also manages a shared storage device 140 and provisions storage resources for the cluster (e.g., one or more virtual disks 141 for each of VMs 157) from shared storage device 140.

Each of the host computers includes a hypervisor 158 (more generally, “virtualization software”) and a hardware platform 159. Hardware platform 159 contains components of a conventional computer system, such as one or more central processing units, system memory in the form of dynamic and/or static random access memory, one or more network interface controllers connected to a network 120, and a host bus adapter connected to shared storage 140. In some embodiments, hardware platform 159 includes a local storage device, such as a hard disk drive or a solid state drive, and the local storage devices of the host computers are aggregated and provisioned as shared storage device 140.

In the embodiments, security services are provided to various security endpoints, which include VMs 157, through a cloud-based security platform 100, which includes a plurality of services, each of which is running in a container or a VM that has been deployed on a virtual infrastructure of a public cloud computing system. To enable delivery of security services to VMs 157, security agents are installed in VMs 157 and the security agents communicate with cloud-based security platform 100 over a public network 105, e.g., the Internet.

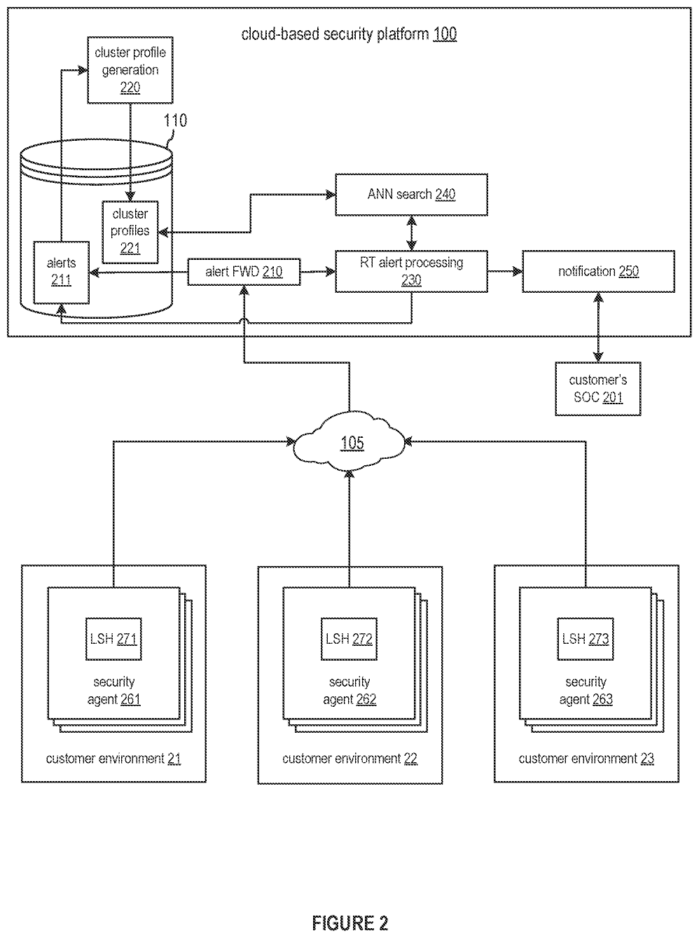

As illustrated in FIG. 2, the services include an alert forwarding service 210, a cluster profile generation service 220, a real-time alert processing service 230, an approximate nearest neighbor search service 240, and a notification service 250. Cloud-based security platform 100 also maintains databases in a storage device 110. The databases include an alerts database 211 and a cluster profiles database 221.

Alert forwarding service 210 routes security alerts that are transmitted to cloud-based security platform 100 by security agents installed in VMs which are provisioned in customer environments that employ security services provided by cloud-based security platform 100. In FIG. 2, three different customer environments, including customer environments 21, 22, 23 depicted in FIG. 1, are shown as an example. The security agents that transmit security alerts to cloud-based security platform 100 include security agents 261 that are installed in VMs of customer environment 21, security agents 262 that are installed in VMs of customer environment 22, and security agents 263 that are installed in VMs of customer environment 23.

Each security agent 261, 262, 263 includes a locality-sensitive hash (LSH) module for computing a locality-sensitive hash of the security alerts prior to transmitting them to cloud-based security platform 100. Therefore, any sensitive information contained in the security alerts is not transmitted to cloud-based security platform 100 in its raw form. As such, the security alerts handled by alert forwarding service 210 are not in their raw form. Instead, they are the LSH of the security alerts in their raw form or the LSH of the security alerts in their raw form that have been transformed in some manner. Example transforms include conversion into lowercase and applying a regular expression. Hereinafter, the security alerts in their raw form will be referred to as “raw security alerts” and the LSH of the raw security alerts or the LSH of transforms of the raw security alerts will be referred to as “LSH security alerts.” In one embodiment, an LSH module that generates a locality-sensitive hash known in the art as TLSH is used in each of security agents 261, 262, 263. This LSH engine is depicted in FIG. 2 as LSH 271 in security agent 261, LSH 272 in security agent 262, and LSH 273 in security agent 263.

In the embodiments, the security agents monitor rules (e.g., watchlist rules) that security domain experts of the corresponding organization have written, and generate security alerts when the conditions of any of the rules are satisfied. For example, one rule may specify that any execution of a PowerShell® command-line should be a trigger for a security alert. In such a case, each time a PowerShell® command-line is executed in a VM, the security agent installed in the same VM generates a corresponding security alert. In addition, the security agents transmit the security alerts to cloud-based security platform 100 along with various attributes of the security alerts. The attributes of each security alert include: (1) timestamp indicating the date and time the security alert was generated, (2) device ID of the endpoint (e.g., VM) in which the security agent that generated the security alert is installed, (3) organization ID of the organization to which the endpoint belongs, and (4) rule ID that identifies the rule which triggered the security alert.

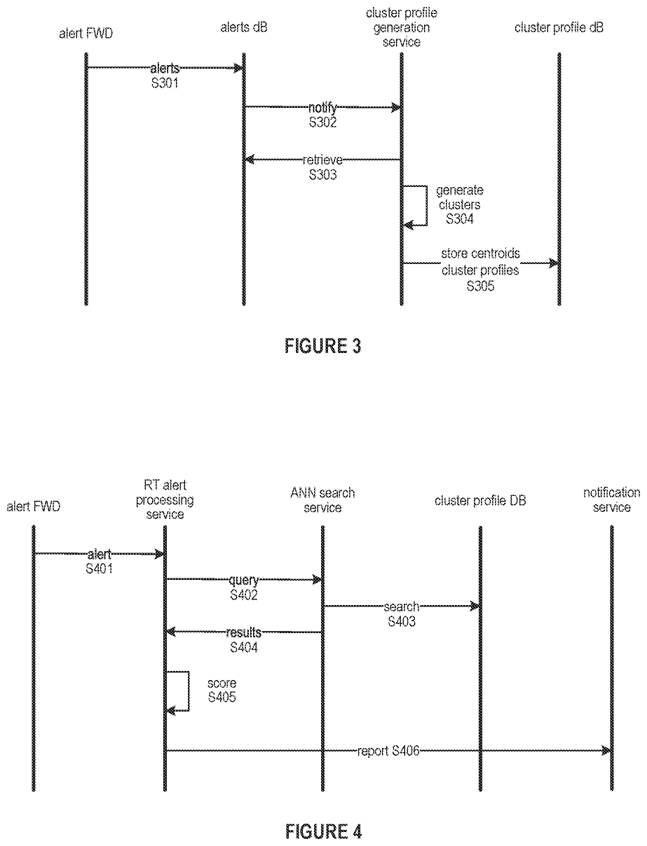

Alert forwarding service 210 routes the LSH security alerts and the associated attribute data to alerts database 211. FIG. 3 depicts a series of steps that are performed in connection with the LSH security alerts and the associated attribute data routed to alerts database 211, starting with the collection of the LSH security alerts and the associated attribute data in alerts database 211 (step S301). When a threshold number of LSH security alerts are collected in alerts database 211 for processing, cluster profile generation service 220 is notified at step S302. In response to this notification, cluster profile generation service 220 retrieves the group of LSH security alerts collected for processing at step S303 and generates clusters based on the group of LSH security alerts at step S304. Any of the well-known clustering algorithms, e.g., density-based spatial clustering of applications with noise (DBSCAN), k-means, Gaussian mixture models (GMM), and hierarchical agglomerative clustering (HAC), may be applied to the group of LSH security alerts to generate the clusters. After the clusters are generated, for each of the clusters, cluster profile generation service 220 computes a centroid, which is representative of the center all of the LSH security alerts in the cluster, and generates statistical and behavioral properties of the cluster. In one embodiment, the centroid is computed as an average of all LSH values of all of the LSH security alerts in the cluster, and the statistical and behavioral properties of the cluster include radius of the cluster, number of unique security alerts in the cluster, and whether the security alert is generated as a result of an execution of code that is backed by a certificate. At step S305, the cluster profile of each of the clusters generated at step S304, which includes its centroid and its statistical and behavioral properties, are stored in cluster profile database 221.

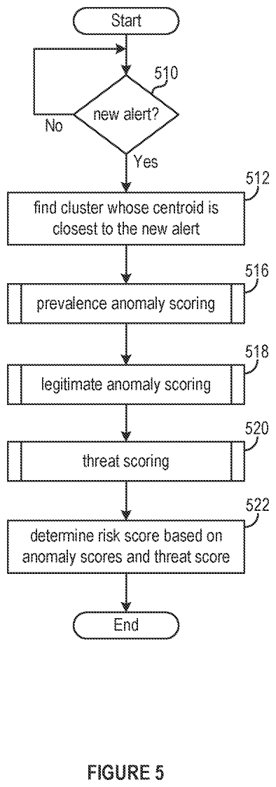

Alert forwarding service 210 also routes the security alerts and the associated attribute data to real-time alert processing service 230. For each security alert routed thereto, real-time alert processing service 230 generates a security risk score for the security alert. FIG. 4 depicts a series of steps that are performed in connection with the security alert routed to real-time alert processing service 230, starting with the receipt of the security alert by real-time alert processing service 230 (step S401). In response to the receipt of the security alert, real-time alert processing service 230 issues a query to approximate nearest neighbor search service 240 at S402 for the cluster whose centroid is closest in distance to the security alert. In response, approximate nearest neighbor search service 240 performs the search on the centroids stored in cluster profile database 221 (step S403) and returns the search result to real-time alert processing service 230 (step S404). In one embodiment, approximate nearest neighbor search service 240 performs the search employing an algorithm known in the art as the nearest neighbor descent (NN-Descent) algorithm. Then, at step S405, real-time alert processing service 230 generates a security risk score for the security alert as described further below in conjunction with FIG. 5. After real-time alert processing service 230 completes the scoring, it reports the security risk score for the security alert to notification service 250 (step S406).

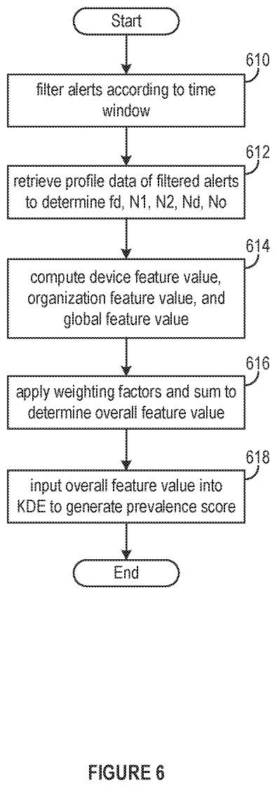

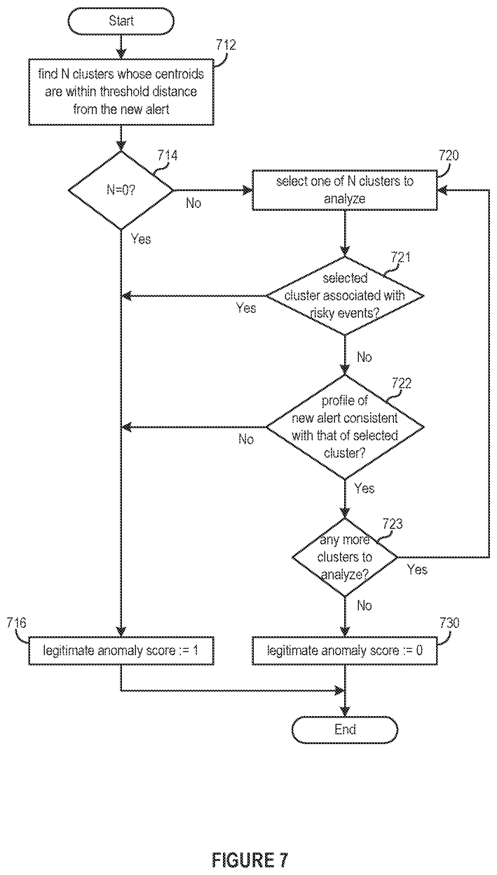

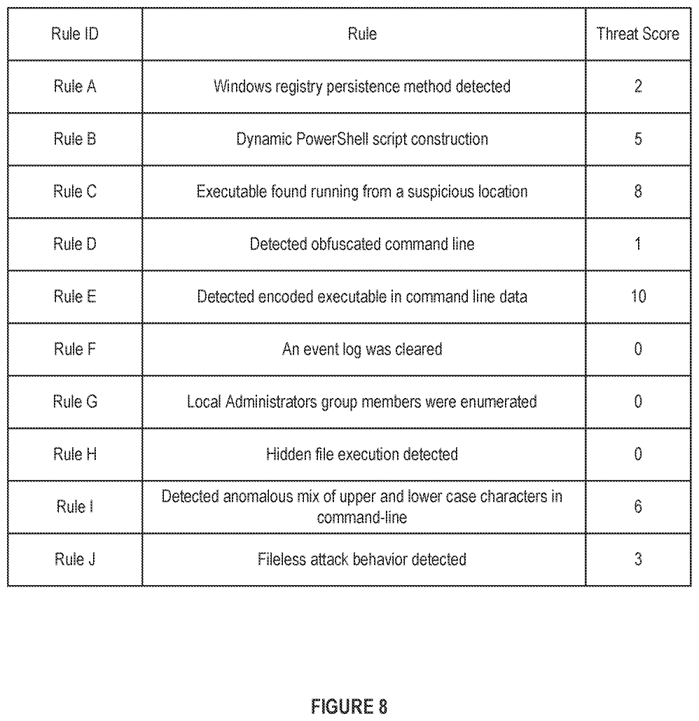

FIG. 5 is a flow diagram of a method of scoring security alerts according to embodiments. The method begins at step 510 when real-time alert processing service 230 receives a new security alert and attribute data of the new security alert. Then, in response thereto, at step 512, real-time alert processing service 230 issues a query to approximate nearest neighbor search service 240 for the cluster whose centroid is closest in distance and within a threshold distance to the security alert. In response, approximate nearest neighbor search service 240 performs the search on the centroids stored in cluster profile database 221 and returns the search result to real-time alert processing service 230. Then, at step 512, real-time alert processing service 230 performs prevalence anomaly scoring in accordance with the method described below in conjunction with FIG. 6 (step 516), legitimate anomaly scoring in accordance with the method described below in conjunction with FIG. 7 (step 518), and threat scoring in accordance with the method described below in conjunction with FIG. 8 (step 520). At step 522, real-time alert processing service 230 determines a security risk score for the security alert based on the three scores obtained through steps 516, 518, and 520. In one embodiment, the two anomaly scores are summed and the threat score is applied to the sum as a multiplier. In other embodiments, weights may be applied to the prevalence anomaly score and the legitimate anomaly score prior to summing. The weights may be set by security domain experts based on their experience or automatically based on a machine learning model that is trained based on the correlation between the magnitude of prior prevalence and legitimate anomaly scores that were generated and security alerts that were further investigated by the security domain experts. In addition, the threat score may be input into a function to generate a multiplier that is applied to the sum. The function may be determined by security domain experts based on their experience or automatically based on a machine learning model that is trained based on the correlation between the multiplier that was applied and security alerts that were further investigated by the security domain experts.

FIG. 6 is a diagram illustrating a prevalence anomaly scoring method implemented in the method of FIG. 5 for a new security alert. The method of FIG. 6 begins at step 610 with the filtering of security alerts according to a predefined time window. In one embodiment, the time window is predefined to be a 7-day time window that begins 7 days before the current date and time. If a cluster whose centroid is closest in distance and within a threshold distance to the new security alert was found at step 512 (hereinafter referred to as the “closest cluster”), the security alerts are further filtered so that only the security alerts that are in the closest cluster and were triggered within the 7-day time window remain. If there is no cluster whose centroid is within a threshold distance to the new security alert, the new security alert is processed as a singleton and the security alerts are further filtered so that only the security alerts that have the same LSH value and were triggered within the 7-day time window remain. The filtering is carried out by real-time alert processing service 230 performing a search of alerts database 211 for all alerts of the closest cluster (or alternatively all identical alerts) that were generated during the 7-day time window. Then, at step 612, real-time alert processing service 230 retrieves attribute data associated with the filtered alerts, and determines fd (which represents the total number of filtered alerts), N1 (which represents the number of filtered alerts generated by devices that are within the same organization as the device that generated the new alert), N2 (which represents the number of different organizations served by cloud-based security platform 100 that own or have administrative control over devices that generated the new alert), Nd (which represents the total number of devices that are equipped with security agents to generate security alerts), and No (which represents the total number of different organizations served by cloud-based security platform 100). The values of fd, N1, N2, Nd, No are then input into Equations 1, 2, and 3 below to compute “device feature value,” “organization feature value,” and “global feature value,” respectively (step 614).

“device feature value”=[1/(1+log(1+fd))] Equation 1:

“organization feature value”=[1/(1+log(1+fd))]×[log(N1/Nd)] Equation 2:

“global feature value”=[1/(1+log(1+fd))]×[log(N2/No)] Equation 3:

After the feature values are computed at step 614, real-time alert processing service 230 at step 616 applies weighting factors to each of the feature values and sums the weighted feature values to determine the overall feature value. In one embodiment, the sum of the weighting factors is 1 so that the overall feature value is in a range from 0 to 1. The weighting factors may be defined by security domain experts based on their experience or automatically based on a machine learning model that is trained based on the correlation between the magnitude of prior feature values and the security alerts that were further investigated by the security domain experts. The overall feature value is then input into a KDE (Kernel Density Estimator) to generate a prevalence anomaly score according to an alert distribution defined by security domain experts (step 618). Any of the KDEs known in the art may be used at step 618.

FIG. 7 is a diagram illustrating a legitimate anomaly scoring method implemented in the method of FIG. 5. The legitimate anomaly scoring method of the embodiments represents an anomaly scoring method for a security alert that is based on how similar the security alert is to a cluster of security alerts that are known to be triggered by malicious activities and how dissimilar the security alert is to a cluster of security alerts that are known to be triggered by legitimate activities. In the embodiments illustrated herein, the result of such legitimate anomaly scoring is either 0 or 1. However, different legitimate anomaly scoring may be employed in other embodiments, so that the result of legitimate anomaly scoring is in a range from 0 to 1.

The method of FIG. 7 begins at step 712 where real-time alert processing service 230 issues a query to approximate nearest neighbor search service 240 for N clusters whose centroids are within a threshold distance from the new security alert received at step 510. In response, approximate nearest neighbor search service 240 performs the search on the centroids stored in cluster profile database 221 and returns the search results to real-time alert processing service 230. If no centroids are within the threshold distance from the new security alert, the search results returned to real-time alert processing service 230 indicate N=0. In such a case (step 714, Yes), real-time alert processing service 230 at step 716 assigns a legitimate anomaly score of 1 to the new security alert. If N is not zero and there are clusters whose centroids are within the threshold distance from the new security alert, steps 720-723 are carried out for each such cluster.

In step 720, real-time alert processing service 230 selects one of the N clusters. Then, real-time alert processing service 230 determines whether or not the selected cluster is associated with potentially risky events (i.e., contains security alerts of the type that are triggered by malicious activities). If so (step 721, Yes), real-time alert processing service 230 executes step 716 to assign the legitimate anomaly score of 1 to the new security alert. If not (step 721, No), step 722 is executed to determine whether or not the profile of the new security alert is consistent with the profile of the selected cluster. One or more of the statistical and behavioral properties stored as the cluster profile in cluster profile database 221 may be compared with the corresponding property of the new security alert to make the determination in step 722. If the profiles are not consistent (step 722, No), real-time alert processing service 230 executes step 716 to assign the legitimate anomaly score of 1 to the new security alert. If they are (step 722, Yes), step 723 is executed next to determine if there are any more of the N clusters to analyze. If there are more clusters to analyze (step 723, Yes), a new cluster is selected at step 720 and steps 721-723 are repeated. If not (step 723, No), real-time alert processing service 230 at step 730 assigns a security risk score of 0 to the new security alert.

FIG. 8 is a look-up table employed in a threat scoring method implemented in the method of FIG. 5. The look-up table is a relational table where each row represents a different rule for triggering security alerts and the columns represent attributes of the rules. As depicted, the first column is for the rule ID and the second column is for the threat score. The threat score is assigned to each rule by security domain experts who wrote the rule, based on their experience on the severity of a security breach associated with activities that trigger the rule. The threat scoring of step 520 is carried out by performing a search of the look-up table of FIG. 8 for the threat score corresponding to the rule that triggered the new security alert.

In the embodiments, a security alert is processed without exposing the raw contents of the security alert. Therefore, the privacy of any sensitive information contained in the security alert is maintained. In addition, embodiments are applicable to behavioral events, which are fundamentally different from files and spams, which are objects of typical security software. The techniques described herein are also scalable. Forming the cluster profiles and reducing the search space enables security analysis to be performed on new events hitting client devices in real-time.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system. Computer readable media may be based on any existing or subsequently developed technology for embodying computer programs in a manner that enables them to be read by a computer. Examples of a computer readable medium include a hard drive, NAS, read-only memory (ROM), RAM (e.g., flash memory device), Compact Disk (e.g., CD-ROM, CD-R, or CD-RW), Digital Versatile Disk (DVD), magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, modifications, additions, and improvements may fall within the scope of the appended claims.

What is claimed is:

1. A method of scoring alerts generated by a plurality of endpoints, said method comprising:
in response to a new alert generated by a first endpoint of the plurality of endpoints, generating an anomaly score of the new alert;
identifying a rule that triggered the new alert and determining a threat score associated with the rule; and
generating a security risk score for the new alert based on the anomaly score and the threat score and transmitting the security risk score to a security analytics platform of the endpoints.

2. The method of claim 1, wherein the anomaly score of the new alert is generated based on a prevalence of prior alerts that are similar to the new alert.

3. The method of claim 2, wherein the anomaly score of the new alert is generated further based on a number of endpoints within a same organization as that of the first endpoint, that generated the prior alerts that are similar to the new alert.

4. The method of claim 1, further comprising:
dividing a plurality of prior alerts generated by the endpoints into a plurality of groups and assigning an anomaly score to each of the groups; and
classifying the new alert into a first group of the plurality of groups, wherein the anomaly score of the new alert is generated based on whether or not any of the alerts in the first group are known to have been triggered by malicious activities.

5. The method of claim 4, wherein the anomaly score of the new alert is generated further based on: (i) a prevalence of the prior alerts that are similar to the new alert, and (ii) a number of endpoints within a same organization as that of the first endpoint, that generated the prior alerts that are similar to the new alert.

6. The method of claim 5, wherein the first group includes the prior alerts that are similar to the new alert.

7. The method of claim 4, wherein
each of the endpoints generates a locality-sensitive hash (LSH) of alerts that are triggered, and
the prior alerts are each represented by an LSH value thereof, and the new alert is represented by an LSH value thereof.

8. The method of claim 7, wherein the LSH value of the new alert is closer to a centroid of LSH values of the prior alerts in the first group relative to a centroid of LSH values of the prior alerts in any of the other groups.

9. The method of claim 4, wherein the groups are clusters which were generated by a clustering algorithm applied to the plurality of prior alerts generated by the endpoints.

10. The method of claim 1, wherein the method is carried out by a cloud platform that delivers security services to a plurality of tenants over a network and the endpoints are computing devices communicating with the cloud platform over the network.

11. A cloud platform for collecting and scoring alerts generated by a plurality of endpoints, the cloud platform comprising:
a data store in which a plurality of prior alerts are stored; and
a processor that is programmed to carry out the steps of:
in response to a new alert generated by a first endpoint of the plurality of endpoints, generating an anomaly score of the new alert;
identifying a rule that triggered the new alert and determining a threat score associated with the rule; and
generating a security risk score for the new alert based on the anomaly score and the threat score and transmitting the security risk score to a security analytics platform of the endpoints.

12. The cloud platform of claim 11, wherein the anomaly score of the new alert is generated based on a prevalence of prior alerts that are similar to the new alert and are generated by the endpoints, and a number of endpoints within a same organization as that of the first endpoint, that generated the prior alerts that are similar to the new alert.

13. The cloud platform of claim 11, wherein the method further comprises:
dividing a plurality of prior alerts generated by the endpoints into a plurality of groups and assigning an anomaly score to each of the groups; and
classifying the new alert into a first group of the plurality of groups,
wherein the anomaly score of the new alert is generated based on whether or not any of the alerts in the first group are known to have been triggered by malicious activities.

14. The cloud platform of claim 13, wherein the anomaly score of the new alert is generated further based on: (i) a prevalence of the prior alerts that are similar to the new alert, and (ii) a number of endpoints within a same organization as that of the first endpoint, that generated the prior alerts that are similar to the new alert.

15. The cloud platform of claim 14, wherein the first group includes the prior alerts that are similar to the new alert.

16. The cloud platform of claim 13, wherein the groups are clusters which were generated by a clustering algorithm applied to the plurality of prior alerts generated by the endpoints.

17. A non-transitory computer-readable medium comprising instructions that are executable in a processor of a computer system to carry out a method of scoring alerts generated by a plurality of endpoints, said method comprising:
in response to a new alert generated by a first endpoint of the plurality of endpoints, generating an anomaly score of the new alert;
identifying a rule that triggered the new alert and determining a threat score associated with the rule; and
generating a security risk score for the new alert based on the anomaly score and the threat score and transmitting the security risk score to a security analytics platform of the endpoints, wherein
the anomaly score of the new alert is generated based on: (i) a prevalence of the prior alerts that are similar to the new alert, and (ii) a number of endpoints that generated the prior alerts that are similar to the new alert and are within a same organization as that of the first endpoint.

18. The computer-readable medium of claim 17, wherein the method further comprises:
dividing a plurality of prior alerts generated by the endpoints into a plurality of groups and assigning an anomaly score to each of the groups; and
classifying the new alert into a first group of the plurality of groups,
wherein the anomaly score of the new alert is generated further based on whether or not any of the alerts in the first group are known to have been triggered by malicious activities.

19. The computer-readable medium of claim 18, wherein the first group includes the prior alerts that are similar to the new alert.

20. The computer-readable medium of claim 17, wherein
each of the endpoints generates a locality-sensitive hash (LSH) of alerts that are triggered, and
the prior alerts are each represented by an LSH value thereof, and the new alert is represented by an LSH value thereof.
